(19) United States
(12) Patent Application Publication
(10) Pub. No.: US 2003/0224082 A1
(43) Pub. Date: Dec. 4, 2003

(54) Microwave molding of polymers

(76) Inventor: Razmik L. Akopyan, Olathe, KS (US)

Correspondence Address: SHUGHART THOMSON & KILROY, PC, 120 WEST 12TH STREET, KANSAS CITY, MO, 64105, US

(21) Appl. No.: 10/435,315

(22) Filed: May 9, 2003

Related U.S. Application Data
(63) Continuation-in-part of application No. 10/157,324, filed on May 29, 2002.

(51) Int. Cl. B29C 35/08; B29B 13/00

(52) U.S. Cl. 425/174.4; 219/756

(57) ABSTRACT

A mold for uniform heating and molding of work material to form a workpiece of variable thickness using a microwave oven includes upper and lower mold members and a sidewall mold member. Metal inserts, with irregular inner surfaces defining a mold cavity, are positioned adjacent opposed planar surfaces of the upper and lower mold members. The mold members are formed from material selected to have an effective thermosensitivity equal to that of the work material. The effective thermosensitivity of work material is its dissipation factor divided by the product of its dielectric constant, density and specific heat multiplied by the fraction of the mass of work material divided by the total mass of work material and metal inserts. The effective thermosensitivity of the material of inner layer of mold member is its dissipation factor divided by the product of its dielectric constant, density, and specific heat and multiplied by the fraction of the mass of its inner mold layer divided by the total mass of this mold member.

This U.S. Patent application is a continuation in part of the U.S. patent application Ser. No. 10/157,324 filed May 29, 2002.

### BACKGROUND OF THE INVENTION

This invention relates generally to microwave processing of high performance polymers and composites, and the sintering of ceramics, and more specifically to the design of molds for processing of such materials including the selection or modification of materials to form the mold to provide for uniform heating of polymers, composites or ceramics by microwave energy.

Efforts to use radio frequency (RF) or microwave processing of polymers and composites has been pursued over the past few decades and yields substantial advantages. In contrast to conventional thermal treatments, the advantages of RF and microwave processing include rapid volumetric heating, avoidance of overheating at the surface, reduced processing time and reduced degradation of the processed polymers. RF dielectric heating may be efficient in applications where uniform volumetric heating is required for workpieces of large volumes and dimensions. RF heating has found a wide range of applications including the drying of wood, the gluing of wood and plastic products, and plastic sealing. Such applications usually employ relatively low radio frequencies (f), i.e. f=13.56 or 27.12 MHz, which are permitted for commercial use. In my U.S. Pat. No. 6,241,929 (hereafter the 929 Patent) I disclosed a method for molding objects of complex shape using RF heating and in my U.S. patent application Ser. No. 10/157,324 (hereafter “patent application”) I disclosed the method and apparatus for molding objects of variable thickness and planar shapes in microwave ovens using microwave energy.

Known techniques for RF dielectric heating are characterized by the presence of two or more metal electrodes electrically separated from each other across which an RF electrical field is applied from a generator, with the work material being placed between the metal electrodes.

In most cases, the efficiency of dielectric heating increases with an increase in the frequency of the electromagnetic field. The preferred frequency whose use is permitted is the frequency allocated for commercial use of microwave, i.e. f=2450±50 MHz. At elevated frequencies of the electromagnetic field, the same heat rating for a particular ii material may be achieved with much lower strengths of the electric field in comparison with lower frequencies. For example, the field strength E at the frequency f=2450 MHz is approximately 10 times less at f=27.12 MHz at the same power rating. At considerably reduced field strengths, the problem of arcing, which is very common for radio frequencies, will be eliminated completely.

At such high microwave frequencies, the design of the applicator for heating the work material is significantly different from an RF applicator with metal plates and conventional open wire circuits. Microwave processing is generally performed within a metallic microwave applicator, which may be a traveling wave applicator, resonant single mode or multimode applicators. The size of such applicators usually exceeds several wavelengths at a given frequency. By definition, microwave frequencies range from 300 MHz to 300 GHz and therefore the applicator size may be about 1 meter or more. The single mode and traveling wave applicators may be used in processing simple material shapes such as fibers. However, the multimode applicator has the capability of coupling microwave energy onto materials of large and complex shape.

The multimode applicator generally comprises a closed metal box having a cavity or chamber and some means of coupling to a power source or generator such as waveguides or antennas. The dimensions of the cavity should be several wavelengths long in at least two dimensions. Such a box will support a large number of resonant modes in the applicator cavity in a given frequency range. When the applicator is not loaded, each of these modes is characterized by a sharp resonance at a given frequency. It is important to provide as many of these modes as possible to lie near the operating frequency of the microwave generator (or generators). When such an applicator is loaded with a microwave absorbing work material, the resonance curves will overlap to give a continuos coupling into the load. The overall distribution of electromagnetic energy is not uniform throughout the microwave cavity or the work material resulting in high and low energy field areas. Such hot and cold spots can be observed in household microwave ovens and are tolerated for food applications, because relatively high thermal conductivity of water containing food results in reductions of the thermal variations established due to non-uniform heating. But this is not the case for high performance polymers since most of these polymers exhibit very poor thermal conductivity. Any attempt to heat the polymer work material (the material to be molded) in a conventional microwave oven without specially designed molds will lead to overheating or burns of the polymer in some places while in other places the work material will be under heated or cured. Uniformity of heating is therefore of great importance in the case of polymer processing.

There have been numerous attempts in the prior art to achieve uniform microwave fields in the volume of a workpiece to be heated. Examples of such techniques include multiple slot entry techniques or the development of “stirred” multimode cavities, in which the field is constantly scanning in order to average out hot and cold spots. While these methods provide some improvement, it has not been possible to achieve the desired uniformity of the temperature field in the work material. Better uniformity of the temperature field can be obtained at a frequency of 2450 MHz by substantially increasing the cavity dimensions (approximately 100 wavelengths) which will require a very large microwave power supply to produce sufficient energy density within the cavity of 12 meters in at least one dimension. A more feasible way is to employ higher frequencies, as high as 28 GHz, where 100 times the wavelength is approximately 1 meter in at least one dimension. However, operation of microwave ovens at a frequency of 28 GHz is considered too expensive and is out of the permitted frequency range.

Another known technique is the excitation of multiple standing-wave modes in the microwave cavity by a plurality of magnetrons. For example, a commercial microwave oven designed for the food industry, such as Panasonic model NE-3280, has 3.2 kW of microwave power and is powered by four magnetrons. Uniformity of heating is significantly improved using such a microwave oven. Polymer processing in such microwave ovens will require specially designed molds for each particular polymer or polymer groups.

Recently developed variable frequency microwave (VFM) ovens may offer an advantage in polymer processing. The advantage of VFM processing over conventional fixed frequency microwave processing is its ability to provide uniform heating over a large volume of a work material (the material to be molded). With VFM heating, a large number of frequencies are introduced into the cavity sequentially during sweeping of frequency in a wide frequency range. Each incident frequency establishes a different pattern of heating. When a sufficient bandwidth is used, time-average uniform heating can be achieved with proper adjustment of the frequency sweep rate and sweep range. A disadvantage of such a technique is that presently the maximum microwave power available does not exceed 500 W, and VFM ovens are not generally commercially available. The price of such ovens is expected to be very high in comparison with fixed frequency microwave ovens. Also, VFM ovens operate in the range of frequencies not permitted for commercial use.

A method for the uniform heating of a workpiece or work material in a microwave oven operating at a frequency of 2450 MHz is disclosed in U.S. Pat. No. 5,202,541. The workpiece assembly represents a multilayer structure of ceramic components placed in a powder bed and surrounded by metal rings stacked vertically in the direction of the electric field. The metal rings are electrically separated from each other. The number, dimensions and separation of employed rings in any particular case is determined by trial and experimentation to achieve the desired uniform electrical field. Alternatively, the rings may be placed snugly against one another to create a conductive wall along the electric force lines and surrounding the crucible containing workpiece assembly. It is noted that depending on the dimensions and nature of the load assembly, the location and extent of the various hot and cold regions can vary.

Experimentally it has been shown that regions with undesirably wide variations of temperature arise in the load whenever an attempt is made to increase the size of workload assembly and quantity of heating ceramic components. In the description of U.S. Pat. No. 5,202,541 there is no analysis of the heat exchange between the workpieces, the powder bed, the crucible and the metal rings and how the difference of their dielectric, thermal and mechanical properties will affect the uniformity of heating. It is evident that workpieces may be heated uniformly only if the temperature rise ratings of the workpieces and surrounding medium are equal. At this condition, zero heat exchange between different components will allow the formation of a uniform temperature field over the entire volume of the assembly. As shown hereafter, the matching of the parameter tan δ/εcρ of the work material and surrounding media adjacent to the workpiece is necessary to provide for uniform heating of the whole assembly.

Another drawback of the method disclosed in U.S. Pat. No. 5,202,541 relates to the working condition of the microwave generator. The presence of tall conducting metal rings having a total height comparable with the dimension of microwave cavity may cause significant reflection of microwave energy toward the generator and may affect its safety during operation.

U.S. Pat. No. 4,307,277 discloses a method for microwave heating of a ceramic work-piece. A work piece is surrounded by an inner casing, which is made of microwave absorbing material. An intermediate casing made of a refractory insulator covers the inner casing for thermal insulation purposes. The whole assembly is placed inside a conventional household microwave oven and exposed to microwave radiation. The work material does not absorb microwave energy and is heated by heat radiation from the inner casing or layer. Such an apparatus may provide uniform heating, but only for a small volume work-piece due to its reliance on thermal conductivity whereby heat flows from its surface to the center. Such a method cannot be used for uniform heating of relatively thick work-pieces and will face the same challenges as conventional methods employing infrared radiation.

U.S. Pat. No. 4,617,439 describes a method for uniform heating of a relatively thin planar panel of work material placed between two metal plates and in intimate contact therewith. Such a sandwich structure of metal plates and work material may be stacked in the direction of the electric field. It has been stated that the effect of electric field guiding by the metal plates allows for the control of the distribution of energy within the work material to be heated. The plurality of stacked panels with metal plates there between provides an even distribution of energy in all of the panels. In such a method, the metal panels may have different contours to shape the layers of work material into the desired profile by means of compression and heat. During exposure of the assembly to microwave radiation, the metal panels will not be heated by the microwave energy due to the skin-effect. The purpose of these metal plates is to guide the electric field and equalize the temperature between hot and cold spots in the work material due to their high thermal conductivity. Actually, these plates work as high thermal conductivity heat absorbers. On one hand, the intimate contact of the metal plates with the work material will equalize the temperature in the longitudinal direction between hot and cold spots, but on the other hand, it will cause the flow of heat from the heated work material to the cold plates resulting in radiation of heat from their surfaces and temperature gradients in the direction normal to their interface.

This disadvantage is avoided in the planar mold disclosed in my currently pending patent application Ser. No. 10/157,324. The inner mold layer surrounds the work material and is heated by microwave energy at the same temperature rate as the work material. Flat metal plates with high thermal conductivity, placed on the planar interfaces of the inner mold layers and the work material reduces thermal gradients which may exist in the work material. These plates are also believed to help correct the electric field and make it more uniform. With the proper selection of material to form the mold, thermal gradients on the interface between the mold and the work material may be significantly reduced in both the longitudinal and normal directions.

Simple design and effectiveness of planar molds disclosed in patent application Ser. No. 10/157,324 were described for workpieces of uniform thickness with parallel planar surfaces. In the present invention it is shown that a uniform heating pattern may also be achieved by using planar molds (i.e. generally flat upper and lower surfaces) and complex shape metal inserts with non planar inner surfaces placed between the inner mold layer and the work material. This will allow the use of simple planar ceramic molds for molding polymer products of complex shape in conventional microwave ovens.

### SUMMARY OF THE INVENTION

The present invention provides a molding apparatus comprising a mold formed of mold material and having a cavity therein for placing a polymer material or work material to be molded by microwave energy. The apparatus and associated method are used for heating and molding workpieces of both variable thickness and uniform thickness in conventional microwave ovens and providing uniform heating through their entire volumes. The mold is positioned in the cavity of a multimode microwave oven and is exposed to microwave radiation to heat the mold and workpiece. The mold is defined by top and bottom mold halves and a circumferential side wall. Each of these, at least in part, form the mold cavity when the top and bottom mold halves are advanced toward each other into abutting relationship with the mold material positioned therebetween. The molding apparatus also includes means for compression of the mold halves during the heating cycle. The apparatus for compressing the mold halves are made of microwave transparent materials.

The uniform heating of a planar workpiece in a planar mold may be accomplished by equalizing the relative thermosensitivities tan δ/εcρ of both the mold and work materials. Here, (ε) is dielectric constant, (tan δ) is the dissipation factor, (c) is the specific heat and (ρ) is the density. The presence of thin flat metal inserts on the interface between the planar mold and work material along with the equality of the relative thermosensitivities results in uniform heating of planar workpieces in conventional microwave ovens.

In the present invention, it is shown that under certain conditions uniform heating of variable thickness workpieces in a conventional microwave oven may be provided in a planar mold with metal inserts of a complex shape. These metal inserts have intimate contact with work and mold materials and in part determine the final shape of the workpiece. The basic condition for uniform heating of the work material requires approximate equality of relative thermosensitivities, tan δ/εcρ, of both the mold and work materials. This condition should be modified to account for the relative mass of the complex shape metal inserts with respect to the mass of the work material and the mass of the inner layer of the mold members with respect to the total mass of the mold members. By choosing specific heating regimes for specific shapes of metal inserts, substantially uniform heating of a complex shaped workpiece may be provided.

In one embodiment, the present invention further reduces the total heat energy which accumulates in the mold-and hence reduces the microwave energy losses. This is accomplished by forming the mold from at least two different compositions of mold material. The composition of the mold material of an inner mold layer of each mold member, adjacent or closest to the mold cavity should have approximately the same “effective” thermosensitivity as the work material. An outer layer of the mold, should have a thermosensitivity which is significantly lower than that of both the inner layer and the work material to reduce the total heat energy accumulated in the mold.

The materials used to form the mold layers are created by adding selected materials or additives to a base mold material to provide approximate equality of the “effective” thermosensitivities of work and mold materials. The thermosensitivity of the outer mold layer is preferably at least ten times lower then the same parameter for the inner mold layer.

### BRIEF DESCRIPTION OF THE DRAWINGS

FIG. 1 is a cross-sectional view of a mold of the present invention adapted to mold work material in the planar mold into a variable thickness workpiece in a conventional microwave oven.

FIG. 2 is a cross-sectional view of a variable thickness workpiece and metal inserts, which are helpful in deriving the effective thermosensitivity of the work material.

FIG. 3 is a cross-sectional view of small experimental samples of variable thickness workpieces molded in a planar mold in a microwave oven.

FIG. 4. is a cross-sectional view of a variable thickness workpiece and hollow metal inserts or inserts with portions filled with a first mold material.

FIG. 5 is a cross-sectional view of experimental samples of variable thickness workpieces larger than the samples of FIG. 3 and molded in planar mold in microwave oven.

FIG. 6 is a diagram of operation of a single magnetron microwave oven at different power levels.

FIG. 7 is a diagram of operation of a Panasonic® microwave oven model NE-3280 at different power levels.

### DETAILED DESCRIPTION OF THE INVENTION

This invention relates to microwave processing of polymers and composites, including items of uniform thickness, variable thickness or complex shape. For example, the techniques of the present invention may be used for the molding of complex shaped parts made of high performance thermoplastics sold under the trademarks TORLON® and PEEK®. Parts made of these polymers perform at extremely high temperatures and stresses generally considered too severe for most thermoplastics. Microwave heating may be the only practical method for processing some composites from incompatible components having very different physical properties or when it is essential to provide rapid and uniform heating of the whole composite structure.

As used herein, the polymer, composite, or ceramic materials to be processed in the mold cavity may be referred to as the work material or material to be molded and the part or component to be formed thereby may be referred to as the workpiece or molded part. The work material may be supplied in pellet, powder, liquid or solid form. Although injection molding is widespread, processes for preheating polymer molding powders and pellets are still necessary because for certain end products, compression molding is preferred. For injection molded parts, the thickness of the part to be molded is limited by the relationship of the flow length versus thickness of the workpiece. For example, parts molded from TORLON® which are over ⅝ inches thick, must be compression-molded. Preheating of TORLON® with conventional techniques is very slow due to poor thermal conductivity of the polymer. When using thermal conductivity to heat the work material, heat flows from the polymer surface toward interior regions, which therefore necessitates an extended period of heating time to equalize the temperature through the entire volume of the work material without overheating of its surface. The heating time of conventional heating means may exceed several hours depending on the thickness of the part to be molded. Increased heating time may require the use of grain growth inhibitors, which usually reduces mechanical strength of the polymer. It also boosts energy consumption and the per unit parts cost.

In conventional compression molding processes of polymers, high temperatures, long processing times, and, in some cases, hot pressing must be applied in the fabrication of products to achieve the highest density and minimum porosity. Conventional compression molding of polymers involves the compaction of a polymer powder into the desired shape following by sintering. The powder is placed in a mold and compacted by applying pressure to the mold halves. The compacted powder is usually porous and its porosity depends upon the amount of applied pressure and the resistance of the particles to deformation. The compacted powder is then heated in the conventional oven to promote bonding of the powder particles. The sintering temperature causes diffusion and neck formation between the powder particles resulting in a dense body. The uniform heating and molding of polymers in microwave ovens has unique advantages over conventional compression molding. The use of microwave energy reduces processing time by a factor of 10 or more. The shortened process time minimizes grain growth. A fine initial microstructure retains the same grain size without using grain growth inhibitors and allows achievement of a high mechanical strength. It is believed that the disclosed microwave process will produce products having improved mechanical properties with additional benefits of short processing time and significantly reduced energy usage.

In the present invention, such a molding process may be performed using a planar mold designed for a particular polymer material or polymer groups and the desired shape of work piece. A dielectric compression device for compaction of polymer powder in a microwave oven is part of the mold assembly and provides the necessary compaction of powdered work material during heating cycle.

Conventional molding processes require employment of hydraulic presses, which generally are not compatible with a microwave oven cavity. Therefore, the primary compaction of polymer powder is performed in a mold in a regular press before placing it into the microwave oven. After the polymer powder is compacted to a uniform density, the mold halves are then compressed by a dielectric compression device, i.e., springs, of the mold assembly and the whole mold assembly is then placed into the microwave oven. The compacted powder or work material is then heated in the mold by microwave energy. Upon reaching the sintering temperature, the whole mold assembly is then removed from the microwave oven and placed into a regular press for final compression to obtain the desired shape of the workpiece.

In the embodiment relating to molding of the work material in a planar mold into a workpiece of variable thickness, the employed apparatus includes at least three mold members, top and bottom or upper and lower members and a sidewall, typically made of microwave absorbing ceramic material with selective additives to equalize selected properties of the material forming the first or inner mold layer and the work material. The apparatus includes two metal inserts having non-planar inner surfaces which define the mold cavity in which the workpiece is formed. The mold assembly also includes means for applying compression forces to advance the mold halves toward each other to close the mold assembly. The mold assembly is positioned in the cavity of a conventional multimode microwave oven.

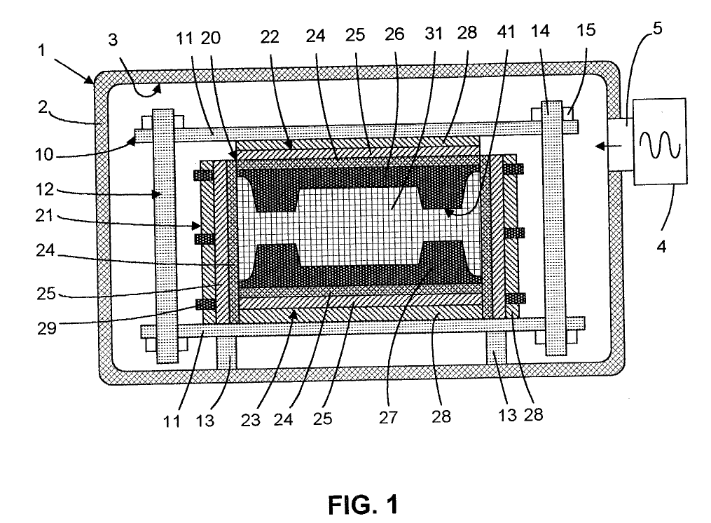

FIG. 1 is a representative view of a mold assembly for demonstrating a planar mold in which uniform heating of polymer material within the mold cavity may be obtained in molding the work material into a workpiece of variable thickness and complex shape.

FIG. 1 generally comprises a diagrammatic view of a microwave oven 1 for molding a workpiece of variable thickness and complex shape. Oven 1 includes a housing 2 defining a microwave resonance cavity 3 into which microwave energy is directed from a generator 4, such as a magnetron, through a waveguide 5 or similar means such as an antenna. The microwave oven shown in FIG. 1 is representative of a multimode microwave oven having a single or plurality of generators 4 and waveguides 5 for generating and directing microwave energy into the microwave resonance cavity to heat the mold and work material. A mold assembly 10 is shown positioned in the microwave resonance cavity 3. The mold assembly 10 includes a compression means 12 supported above a floor of the housing 2 by spacers 13. For microwave ovens with a turntable the turntable itself with its rollers may be considered as spacers 13. Compression assembly 12 comprises two rigid plates 11 and several threaded studs 14 and nuts 15 for drawing or squeezing mold halves 22 and 23 toward each other. A mold 20 is positioned between plates 11. The mold 20 generally comprises a multiple layer sidewall member 21, which may be cylindrical, and planar upper and lower mold members 22 and 23. Sidewall member 21 and each of the mold members 22 and 23 preferably include what may be generally referred to as an inner or first mold layer 24 formed from a first mold material and an outer or second mold layer 25 formed from a second mold material with a very low dissipation factor. This second mold layer 25 may be used if necessary for reinforcement of the upper and lower mold members to withstand high compression forces. Sidewall member 21 may contain only a single layer 24 made from the first mold material and reinforced by metal rings 29. Upper and lower metal inserts 26 and 27 of variable thickness are placed between the work material and the upper and lower mold halves 22 and 23 respectively. These inserts 26 and 27 are made of a metal or alloy with relatively high thermal conductivity. Each insert 26 and 27, includes planar or flat outer surfaces which are positioned in abutting relationship with the parallel planar surfaces formed by the inner mold layer 24 on the upper and lower mold members 22 and 23 as shown in FIG. 1. The metal inserts 26 and 27 have non-planar or irregular inner surfaces which generally define the outer surfaces of a mold cavity 41 in which the workpiece 31 is molded to form a workpiece of complex shape. Mold material positioned in mold cavity 41 generally extends in intimate contact with the non-planar inner surfaces of metal inserts 26 and 27. The inner and outer mold layers 24 and 25 generally surround the mold cavity 41.

As used herein, reference to the metal inserts having high thermal conductivity indicates that the thermal conductivity of their material is high in comparison to the thermal conductivity of the selected work material. It is foreseen that many non-magnetic metals or alloys may be used for making inserts 26 and 27. Non-magnetic grade of stainless steel is an example of such materials. The mold 20 may contain thermal insulating layers 28 to reduce heat radiation from the hot mold during the heating cycle. It also may contain narrow metal rings 29 around circular sidewall member 21 for mold reinforcement. A wide variety of means for compressing the mold could be utilized including different types of springs or hydraulic devices. The materials employed to form the compression means or assembly, 12, including the spacers 13, and insulating layers 28 are preferably transparent to microwaves to reduce microwave energy losses. The work material to be molded into a workpiece 31 is positioned in the mold cavity 41 where it is heated by the microwave energy and compressed by the biasing force of plates 11 on the upper and lower mold members 22 and 23 to compress or form the workpiece into the desired shape.

In order to obtain uniform heating of a planar workpiece of uniform thickness in a mold having opposed planar surfaces defining a mold cavity it is necessary to equalize the relative thermosensitivities of the work and mold materials.

$${( \frac{tan δ}{∈ c ρ} )}_{work} = {( \frac{tan δ}{∈ c ρ} )}_{mold} \qquad ( 1 )$$

Where:

subscripts “work” and “mold” refer to work and mold materials, respectively,

ε=dielectric constant,

tan δ=dissipation factor,

c=specific heat,

ρ=density.

This condition provides equal temperature rise ratings of the work and mold materials and, hence, minimizes temperature gradients between the mold and workpiece and most importantly, through the entire volume of the workpiece. The insertion of flat thin metal plates at the planar mold-workpiece interfaces reduces possible thermal gradients and, also, may correct the electric field in the mold cavity and make it more uniform. It is also noted that some adjustments of the inner mold layer materials may be required to compensate for heat exchange between hot inner and cold outer mold layers. Such an adjustment may have to be increased for an inner mold layer having a lower mass with respect to the mass of the rest of the mold halves.

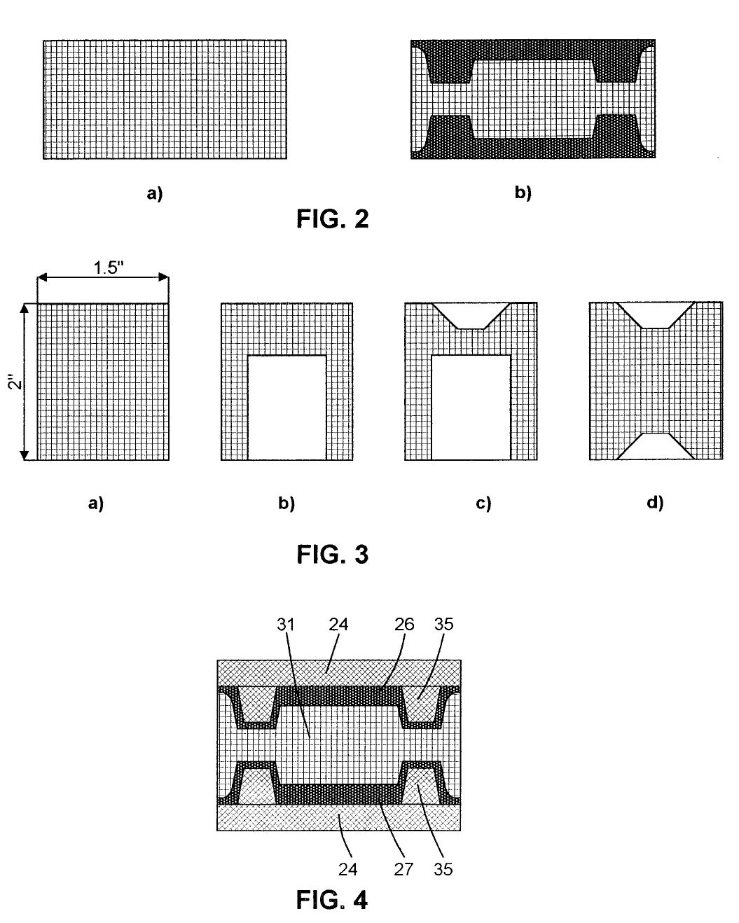

Let us now analyze the case of heating of variable thickness workpieces in a planar mold. As used herein, planar generally means having flat or planar upper and/or lower surfaces. FIG. 2a is the diagrammatic view of a planar work material between planar mold members 22 and 23 without metal inserts 26 and 27, while FIG. 2b is the diagrammatic view of work material 31 containing metal inserts 26 and 27. It may be seen from FIG. 2a that if the work material fills all the space between the planar upper and lower mold members, then more microwave energy will be developed in this space in comparison with the case shown on FIG. 2b. That occurs because no microwave energy will develop in highly electrically conductive non-magnetic materials due to skin-effect. As a result, the total heat energy developed in work material of variable thickness (see FIG. 2b) will be reduced in comparison with the corresponding planar volume of the workpiece (see FIG. 2a). During heating time, heat will flow from the hot work material toward cold metal inserts 26 and 27 reducing the heating rate of the work material. In the same way, the heat will flow from hot inner mold layers toward cold outer layers because they are made of materials with low dissipation factors. These heat exchange processes will reduce temperature rise ratings of both the work and mold materials or, in other words, their effective thermosensitivities will be lower than those given in (1). The extent of these heat exchange processes depends on many factors, but resulting average temperatures are mostly determined by relative mass of hot and cold subjects involved in heat exchange processes. The exact calculation and description of these processes is complex and is out of the scope of present description since final adjustments in mold design should be carried out experimentally. As a first brief approach, we can assume that the use of the metal inserts reduces the relative thermosensitivity of the work material by the factor M_{work}/(M_{work}+Mᵢₙₛₑᵣₜ) and the effective thermosensitivity of the work material may be given by:

$${( \frac{tan δ}{∈ c ρ} )}_{work} \times \frac{{M}_{work}}{{M}_{work} + {M}_{inserts}} \qquad ( 2 )$$

Here:

M_{work}=the mass of work material,

Mᵢₙₛₑᵣₜₛ=total mass of inserts 26 and 27.

In the same way, the effective thermosensitivities of mold members may be given by:

$${( \frac{tan δ}{∈ c ρ} )}_{mold} \times \frac{{M}_{mold , 1}}{{M}_{mold , 1} + {M}_{mold , 2}} \qquad ( 3 )$$

Where:

M_{mold,1}=the mass of inner layer of mold member,

M_{mold,2}=total rest mass of corresponding mold member.

Formula (3) should be applied to each of the mold members 21, 22 and 23 to estimate ii their temperature rise ratings. For more detailed analysis the difference in mechanical and thermal properties of different components of mold members, metal inserts and work material may be taken in to account. It may be seen from formulas (2) and (3) that if Mᵢₙₛₑᵣₜₛ<<M_{work} and M_{mold,2}<<M_{mold,1} then formulas (2) and (3) reduce to condition (1) for a planar workpiece and the effective thermosensitivity will approximately equal the relative thermosensitivity. Now it is clear that if the above defined effective thermosensitivities of the work material and all mold members are approximately equal then their temperature rise ratings will be equal providing approximate thermal equilibrium at any time during the heating process. Thermal gradients in the work material and on the mold-work interfaces may be significantly reduced by choosing a specific regime of heating cycle and will be described later.

The approximate equality of the effective thermosensitivities of the work and mold materials of each mold member given by formulas (2) and (3) can be summarized by the formula:

$$\begin{matrix}{( \frac{tan δ}{∈ c ρ} )}_{work} \times \frac{{M}_{work}}{{M}_{work} + {M}_{inserts}} = {[ {( \frac{tan δ}{∈ c ρ} )}_{mold} \times \frac{{M}_{mold , 1}}{{M}_{mold , 1} + {M}_{mold , 2}} ]}_{member 21} \\ = {[ {( \frac{tan δ}{∈ c ρ} )}_{mold} \times \frac{{M}_{mold , 1}}{{M}_{mold , 1} + {M}_{mold , 2}} ]}_{member 22} \\ = {[ {( \frac{tan δ}{∈ c ρ} )}_{mold} \times \frac{{M}_{mold , 1}}{{M}_{mold , 1} + {M}_{mold , 2}} ]}_{member 23}\end{matrix} \qquad ( 4 )$$

The initial temperature of the work material and the mold members for the first molding shot is usually room temperature. At all the following shots the work material initially is at room temperature while the mold members are at equal and elevated temperatures, approximately 160° F., which corresponds to the mold opening temperature after cooling time. This difference should be taken into account. Another possible source of non-uniform heating may occur when choosing mold materials for mold members given by formula (3). Some miscalculation may result in the lower effective thermosensitivities for one or more mold members. In such a case the temperature rise rating of this mold member (or members) after it is fabricated may be lower then that of the others resulting in a lower final temperature of the mold member by the end of heating time or cycle. To compensate for this miscalculation, this mold member (or members) may be preheated in microwave oven prior to pouring the work material and assembling the mold. The degree of such preheating should be determined by trial. Such adjustments may be carried out by using an experimental prototype mold prior to design of an actual mold.

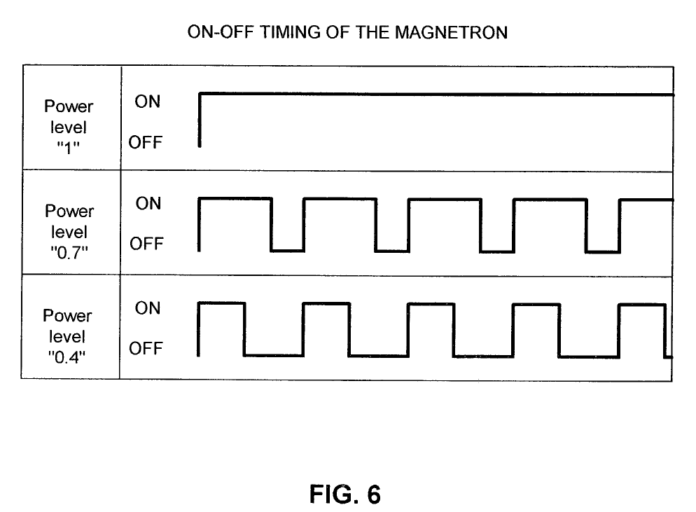

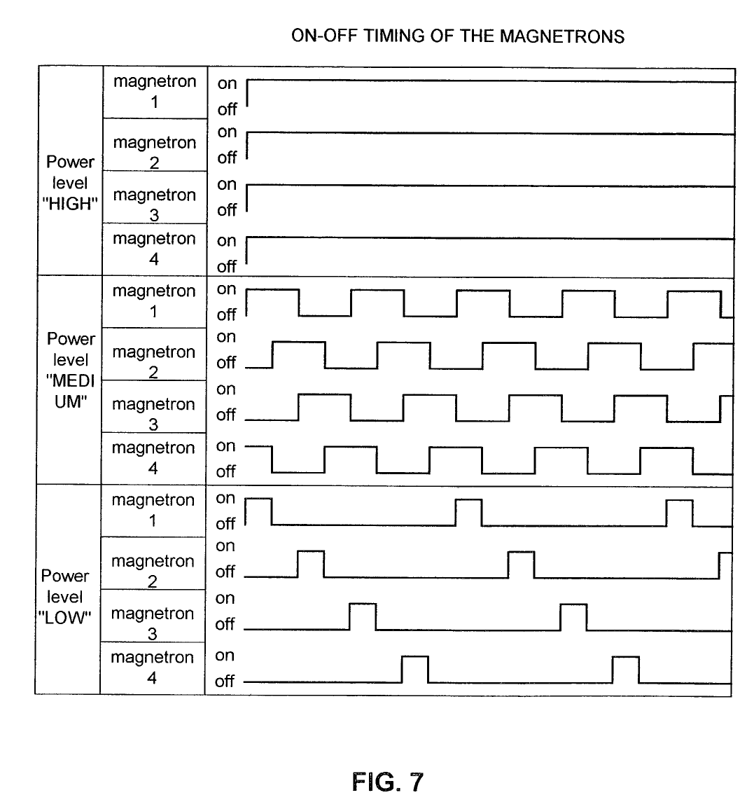

From the above description it follows that there is a wide variety of shapes that can be selected for the metal inserts 26 and 27. Inserts 26 and 27 may differ from each other, they may be replaceable and can provide a wide variety of molded shapes. The above described heating process effectively uses the combination of volumetric and conductive heating. High thermal conductivity of metal inserts along with high thermal conductivity of the inner mold layer material (usually SiC) results in significantly reduced thermal gradients inside the mold cavity due to thermal conductivity. In FIG. 3 there are shown sectional views of different experimental parts molded in the same mold without changing the sidewall, upper and lower mold members. The parts were molded in a 1 kW conventional single magnetron microwave oven from conductive grade of Torlon® powder (30% of carbon) by changing only the upper and/or lower metal inserts. All samples shown in FIG. 3 are circular in cross-section with an outside diameter of 1.5 inches and 2 inches in height. The heating regime for all the samples was the same and consists of three levels of heating power: “high”, followed by “medium” and “low”. In conventional microwave ovens, the average microwave power is usually varied by switching the number of simultaneously working magnetrons and/or by timing when magnetrons are “ON” or “OFF” (see FIG. 6 and FIG. 7). For a single magnetron microwave oven used for molding small experimental samples, the average power level can be varied only by time when the magnetron is “ON” and “OFF” as shown in FIG. 6. The timing may be set by programming on the control panel. For the above-described samples the average power level and timing are shown in Table 1 and as shown diagrammatically in FIG. 6.

TABLE 1

| Heating time | Power level | Description |
|---|---|---|
| 10 minutes | 1 (high) | Steady “ON” |
| 5 minutes | 0.7 (medium) | 70% of time “ON”, 30% of time “OFF” |
| 5 minutes | 0.4 (low) | 40% of time “ON”, 60% of time “OFF” |

The examination of a cross section of the samples shows high quality molding without any signs of porosity or grain growth. Total heating time of all the samples was approximately 20 minutes. During the first 10 minutes of heating time, temperature rise ratings of the work material and mold members are approximately equal and maximal. During the second and third stages, temperature rise ratings are lower which allows reduction of the thermal gradients and equalization of the temperature field inside the mold. During the first stage, the temperature field inside each mold member and work piece is determined mostly by volumetric heating, which is defined by their effective thermosensitivities. During the third stage of heating, the role of conductive heating increases and the heating process is now driven by a combination of volumetric and conductive heating.

In one embodiment relating to the design of metal inserts, the employed apparatus includes hollow metal inserts with openings for reducing the mass of these inserts. From formula (2) it may be found that by reducing the mass of inserts 26 and 27 higher effective thermosensitivity of the work material may be achieved since less amount of heat energy will be removed from work material. This may be done by forming bores or openings 35 in the inserts and filling them with microwave absorbing material as shown in FIG. 4. FIG. 4 shows a portion of a mold enclosing work material 31. The mold includes inserts 26 and 27 with openings 35 and inner mold layers 24 adjacent to these inserts. Openings 35 are filled with the same material as the inner mold layer 24. Direct tests of such hollow metal inserts 26 and 27 shows little or no changes at all in heating patterns. This may be explained by the fact that if such openings in the metal inserts are smaller than the wavelength in the mold material at frequency 2450 MHz, then the electric field will not penetrate into the opening resulting in very small additional heating of this material. So this technique is not effective for small openings in metal inserts 26 and 27 and may be justified only for bigger parts where the dimensions of such openings are comparable or larger than wavelength at a given frequency (4.7 inches at 2450 MHz).

Next, we consider the technique for matching the controlling parameters of the mold and work materials. These technique were developed and described in detail in the “929” Patent. The technique is oriented for processing high performance polymers such as TORLON®, PEEK® and the like, or composites. Conventional silicon based dielectric molds do not have the required mechanical and thermal strength to serve under extreme conditions during processing of high performance thermoplastics. The molding temperature for such thermoplastics may exceed 400° C. and the applied pressure is usually above 2000 psi. Silicone Carbide, SiC or the like was chosen as the base material for the inner layer of a ceramic mold. SiC effectively absorbs RF and microwave energy in a wide temperature range and can be heated easily and quickly from room temperature to well above 500° C. Aluminum Oxide, Al₂O₃ or the like may be used as an additive for the first mold material and as a second base material for the outer mold layer due to its very low dissipation factor and thermal conductivity. The preferred technique is to modify the base mold materials by adding different additives. The base mold materials and additives, which may be used are as follows:

a) SiC—first base mold material for inner layer; has very high dissipation factor,

b) Aluminum Oxide, Al₂O₃—additive to the first base mold material with low dissipation factor for reducing effective thermosensitivity of inner mold layer.

c) It also may be used as a second base mold material for outer mold layer;

d) hollow microspheres with low dissipation factor and low thermal conductivity made by 3M Company may be used for reducing thermal conductivity of second mold layer.

The addition of additives like Al₂O₃ with very low dissipation factor into SiC will modify its dissipation factor depending on the volume fraction of additive and may be given by formula:

$${( tan δ )}_{mixture} = {( tan δ )}_{SiC} \times \frac{1}{1 + {V}_{add} / {V}_{SiC}} \qquad ( 4 )$$

Here:

(tan δ)ₘᵢₓₜᵤᵣₑ=dissipation factor of the mixture,

(tan δ)_{SiC}=dissipation factor of SiC,

V_{add}/V_{SiC}=volume fraction of the additive.

When designing a planar mold for variable thickness workpieces, SiC or the like may be used as the first base mold material forming the inner mold layers. Aluminum Oxide, Al₂O₃ may be added in to inner mold layers to control their effective thermosensitivities and modify them to approach the effective thermosensitivity of the work material. Effective thermosensitivities of mold members may also be effectively varied by choosing a proper thickness of the inner and outer mold layers as is shown in formula (3). Aluminum Oxide, Al₂O₃ may be used as a second base mold material forming the outer mold layer and typically does not require any additives since it has a very low dissipation factor and, hence, very low relative thermosensitivity. The dielectric constant of the first and second mold materials may differ from the dielectric constant of the work material when designing a planar mold. The value of the effective thermosensitivity of the work material should be estimated by the use of formula (2) taking into account the mass of inserts 26 and 27. The value of effective thermosensitivities of each mold members should be estimated from the formula (3) by taking into account the percentage of additives and the mass of each component of the mold members. The mixture of SiC and Al₂O₃ powders for the inner mold layers as well as Al₂O₃ powder for the outer mold layers are consolidated into the desired shape by conventional methods of ceramic processing. Using the above-described technique, the desired mold materials may be created for a wide range of thermal, mechanical and dielectric properties of polymers to be processed.

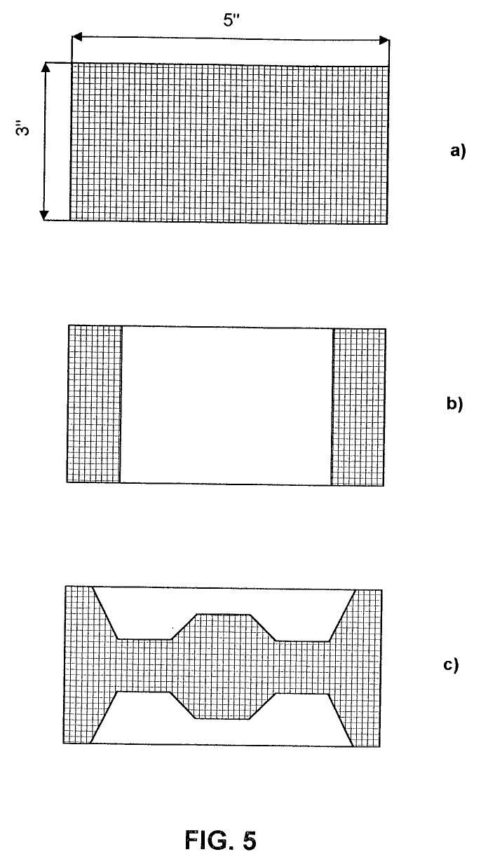

The experimental molds were designed for molding different thermoplastic materials in conventional microwave ovens. Prior to designing actual mold for parts of relatively large dimensions, a small prototype mold was made for small samples as shown in FIG. 3 and described above. After testing such a small mold and necessary adjustments the larger mold was designed for larger workpieces as shown in FIG. 5. The outside diameter of all these parts is 5 inches, their height is approximately 3 inches. Parts were made from the same conductive grade of TORLON® as smaller parts shown in FIG. 3. An examination of a cross-section of these parts reveals the same high quality of molding as for smaller parts without porosity or grain growth. The molding process was performed in a microwave oven model NE-3280 made by Panasonic. The heating regime is given in Table 2. and as shown diagrammatically in FIG. 7.

TABLE 2

| Heating time | Power level | Description |
|---|---|---|
| 15 minutes | medium (≈1.6 kW) | two magnetrons are operating |
| | | simultaneously |
| 10 minutes | low (≈0.6 kW) | one of the magnetrons is |
| | | operating at a time |

Power levels are internally programmed and may be set on keypad of the control panel. FIG. 7 diagrammatically shows switching of magnetrons during operation at different power levels. The total heating time was approximately 25 minutes. A variety of industrial microwave ovens are available for molding of polymer parts of much larger dimensions then that shown in FIG. 3 and FIG. 5.

Based on the above analysis and on examination of molded parts of different shapes and dimensions, a conclusion was made that using the methods described herein, planar molds can be effectively used for molding both planar and variable thickness objects of complex shapes, due to the simplicity of the molds and the ability to provide uniform heating in a conventional microwave ovens.

The absorption of microwave energy by different polymers may vary widely. Some polymers are transparent to microwaves while others may be highly conductive and require some care during microwave processing. Semitron® and most TORLON® grades are good candidates for RF/microwave processing and may be effectively heated from room temperature. With regard to PEEK®, its conductive grades 450CA30 and 450FC30 may be easily heated from room temperature since they have a relatively high dissipation factor at room temperature. Other PEEK® grades have very low dissipation factors (approximately 0.003) and will not heat when subjected to microwave radiation at room temperature. If these PEEK® materials of low loss grades are preheated by conventional means up to 160° C., their dissipation factors rapidly increase to values over 0.02. Starting at or above 160° C., these thermoplastics may be effectively heated and molded by the above described technique. The examples of microwave molding discussed above demonstrate the utility of the method and apparatus disclosed in the present invention for effective microwave molding of planar and variable thickness products of complex shapes made of high performance polymers.

It is to be understood that while certain forms of the present invention have been illustrated and described herein, it is not to be limited to the specific forms, arrangement of parts, combinations of ingredients or process steps described and shown.

What is claimed is:

1. An apparatus for heating a work material using microwave radiation in a resonance cavity of a microwave oven, the work material to be molded into a workpiece of variable thickness comprising: a mold positionable in the resonance cavity of said microwave oven; said mold comprising an upper mold member, a lower mold member and a sidewall mold member surrounding a mold cavity; said upper and lower mold members having opposed parallel planar inner surfaces, said mold further including a metal insert of high thermal conductivity positioned adjacent a respective one of said parallel planar inner surfaces of said upper and lower mold members, each insert having a non-planar inner surface adjacent to said mold cavity to define upper and lower boundaries of said mold cavity; said mold adapted to receive the work material in said mold cavity; a first mold layer of said sidewall mold member and said upper and lower mold members being formed from a first mold material selected so that the first mold layer of each mold member has an effective thermosensitivity approximately equal to an effective thermosensitivity of the work material, such that exposing said mold to microwave radiation in said microwave oven results in relatively uniform heating of the work material to a selected temperature; wherein the effective thermosensitivity of the work material is equal to the dissipation factor of the work material divided by the product of its dielectric constant, density and specific heat and multiplied by the fraction of the mass of the work material divided by the total mass of the work material and the upper and lower metal inserts; and wherein the effective thermosensitivity of the first mold layer of each mold member is equal to the dissipation factor of the mold material divided by the product of its dielectric constant, density and specific heat and multiplied by the fraction of the mass of the respective first mold layer divided by the total mass of the respective mold member.

2. The apparatus of claim 1 wherein:
a) each of said mold members includes a second mold layer formed from a second mold material and positioned adjacent said first mold layer on a side opposite said mold cavity; said second mold material having a relative thermosensitivity which is lower than the effective thermosensitivity of the first mold layer of each of said mold members and said work material.

3. A process for creating a mold for use in a microwave oven for providing relatively uniform heating to a selected temperature of a work material positioned in a mold cavity of the mold to form a workpiece of variable thickness through the exposure of the mold and the work material to microwave radiation in the microwave oven; said process comprising:
a) forming the mold to include upper and lower mold members having opposed parallel planar inner surfaces and a circumferential sidewall mold member; each mold member including a first mold layer surrounding a mold cavity and formed from a first mold material selected such that said first mold layer of each mold member has an effective thermosensitivity approximately equal to an effective thermosensitivity of the work material;
b) positioning upper and lower metal inserts of high thermal conductivity adjacent the opposed parallel planar inner surfaces of the upper and lower mold members;
the metal inserts having non-planar surfaces adjacent the mold cavity forming boundaries of the mold cavity, such that application of a microwave electric field across the mold results in approximately equal temperature rise ratings of each mold member and the work material positioned in the mold cavity to the selected temperature.

4. The process as in claim 3 wherein:
a) said step of forming said mold members comprises forming a second layer of said mold members from a second mold material adjacent said first layer of each mold member on a side opposite said mold cavity; said second mold material selected to have a dissipation factor which is lower than the dissipation factor of said first mold material and said work material.

5. The process as in claim 4 wherein:
a) said step of forming said mold includes selecting the first mold material of each mold member such that said first mold layer of each mold member has an effective thermosensitivity approximately equal to the effective thermosensitivity of the work material and selecting the second mold material to have a dissipation factor lower than the dissipation factor of the first mold material by at least a factor of ten.

6. A process for creating a mold for use in a microwave heating apparatus for providing relatively uniform heating to a selected temperature of a work material positioned in a mold cavity of the mold to form a workpiece of variable thickness through the exposure of the mold and the work material positioned therein to the electric field of a microwave oven; said mold comprising an upper mold member, a lower mold member and a sidewall mold member surrounding the mold cavity and each of said mold members having at least a first mold layer; the process comprising:
a) determining the effective thermosensitivity of the work material;
b) determining the relative size of each mold member including the relative size of the first mold layer of each mold member;
c) selecting a first base mold material and determining the effective thermosensitivity of the first mold layer of each mold member formed from said first base mold material;
c) identifying a first additive material which may be added to the first base material to produce a first mold material wherein the effective thermosensitivity for the first mold layer of each mold member formed from said first mold material will be approximately equal to the effective thermosensitivity of the work material;
d) adding the first additive material to a quantity of the first base mold material in an amount sufficient to produce the quantity of first mold material necessary to produce the first mold layer of each mold member having an effective thermosensitivity approximately equal to effective thermosensitivity of the work material;
e) forming the first layer of each mold member from the first mold material and forming the first layer to surround a mold cavity and to include opposed parallel planar inner surfaces on the upper and lower mold members;
f) placing an upper and lower metal insert of high thermal conductivity and a non-planar inner surface adjacent each opposed parallel planar inner surface of the first layer of the upper and lower mold members respectively, the non-planar inner surfaces of each metal insert defining an outer surface of the mold cavity.

7. The process as in claim 6 wherein each mold member includes a second mold layer adjacent the first mold layer and wherein the step of:
a) determining the size of each mold member includes determining the relative size of the second mold layer of each mold member
b) selecting a second base mold material and determining its dissipation factor; and
c) forming the second mold layer from the second base mold material.

8. The process of claim 7 wherein the dissipation factor of the second mold material is lower then the dissipation factor of the first mold material by at least ten times.

9. An apparatus for heating work material in the resonance cavity of a multimode microwave oven to form a workpiece of variable thickness comprising:
a) a mold positionable in the resonance cavity of the microwave oven; said mold containing a side wall member, an upper mold member and a lower mold member; each of said mold members having a uniform thickness and formed from at least a first layer of a first mold material surrounding a mold cavity; said upper and lower mold members having opposed parallel planar inner surfaces; said mold further having metal upper and lower inserts each having a planar face positioned adjacent a respective one of the opposed parallel planar inner surfaces of said upper and lower mold members and having a non-planar inner surface defining an outer surface of said mold cavity; said mold adapted for receiving the work material in said mold cavity; said first mold material of each mold member selected such that said first layer of each mold member has an effective thermosensitivity approximately equal to an effective thermosensitivity of the work material, such that exposing the mold to a microwave field of the microwave oven results in relatively uniform heating of the work material to a selected temperature; wherein the effective thermosensitivity of the work material is equal to the dissipation factor of the work material divided by the product of its dielectric constant, density and specific heat and multiplied by the fraction of the mass of the work material divided by the total mass of the work material and the upper and lower metal inserts; and wherein the effective thermosensitivity of the first mold layer of each mold member is equal to the dissipation factor of the mold material divided by the product of its dielectric constant, density and specific heat and multiplied by the fraction of the mass of the respective first mold layer divided by the total mass of the respective mold member.

10. The apparatus of claim 9 wherein:
a) at least one of said metal inserts is hollow and contains openings filled by microwave absorbing material to increase the total microwave energy developed in said mold cavity.
